(19) United States
(12) Patent Application Publication
(10) Pub. No.: US 2026/0201735 A1
(43) Pub. Date: Jul. 16, 2026

(54) A DRAWER DISPLACEMENT RESTRICTION SYSTEM AND A CHEST OF DRAWERS USING SUCH SYSTEM

(71) Applicant: Inter IKEA Systems B.V., Delft (NL)

(72) Inventor: Erik BERGQVIST, Malmö (SE)

(21) Appl. No.: 19/137,713

(22) PCT Filed: Dec. 11, 2023
(86) PCT No.: PCT/SE2023/051238

§ 371 Date: Jun. 11, 2025

(30) Foreign Application Priority Data
Dec. 14, 2022 (SE) 2251457-4

(51) Int. Cl. E05B 65/466; A47B 88/50

(52) U.S. Cl. CPC E05B 65/466; A47B 88/50

(57) ABSTRACT

A drawer displacement restriction system including at least two drawers, each drawer having a rear panel connecting with two opposing side panels. The system further includes at least two pairs of wire guiding members, each pair being configured to be supported by a wall of the chest of drawers in a position adjacent a respective drawer. Additionally, the system includes a wire being configured to extend along a wall of the chest of drawers and through a channel in each wire guiding member in the at least two pairs of wire guiding members; and at least two pulling members. Each of the drawers is configured to support a respective pulling member. One of the pulling members is configured to selectively engage the wire in a position between two wire guiding members in a pair of wire guiding members during opening of a drawer associated with the pulling member.

### TECHNICAL FIELD

The present invention refers to a drawer displacement restriction system, a chest of drawers and an aggregate to be used in a drawer displacement system.

### TECHNICAL BACKGROUND

A chest of drawers is a classical piece of furniture to store items in homes. The width and depth respectively of the chest of drawers is typically substantially smaller than the height. Thereby a large storing capacity is provided for while only requiring a limited footprint. Each drawer defines a storing volume and as a drawer is opened, the center of mass will be displaced. This is in most cases never a problem since the underlying working principle of a chest of drawers is to pull out drawers to get access to the contents. It is however never possible to foresee how a piece of furniture is used in practice and in the worst-case scenario, the chest of drawers may tip over and cause severe personal injuries. Typical risks are when the drawers at a higher level are filled with a heavy load and opened, or when a person is leaning over or seeks support against the chest or a pulled-out drawer. The latter may especially be the case when children are using the chest of drawers, either when trying to get access to its contents by climbing, or simply playing around. One way is to prevent the number of drawers that may be opened at a time.

Such systems are well known in the art. EP 1 149 971 A1 discloses one example of a safety mechanism for telescopic shelves. The safety mechanism comprises a flexible member that runs vertically and passes through eyelets on the shelves. The flexible member passes through further eyelets at the top and bottom of the cabinet. Also, the flexible member is attached in each end to stop ends which in turn are fixed to the cabinet. Tension is maintained in the flexible member by springs that are attached between the cabinet and the two stop ends. The safety mechanism which as such is simple, is however complex when it comes to mounting. Another example is found in NL8902692. A flexible band extends in the vertical direction along the rear wall of the cabinet. Also, each drawer is provided with a pin in a rear end thereof. The side wall of the cabinet is provided with a plurality of guide pins. As one drawer is pulled to be opened, the pin of the drawer pulls the band which is forced to bend around two adjacent pins in the cabinet. The safety mechanism which as such is simple, is however complex when it comes to mounting due to the necessity to thread the flexible band between a number of pins arranged in the back of the chest of drawers.

There is hence a need for a system that is applicable also for the type of furniture's that are configured to be assembled by the end user herself.

### SUMMARY

An object of the present invention is to provide a drawer displacement restriction system which is easy to mount while assembling the furniture, and especially in the event the furniture is a chest of drawers.

Another object is to provide a drawer displacement restriction system that has a design that makes it necessary to be mounted to the chest of drawers in order of allowing the chest of drawers to be properly used.

Yet another object is to provide a drawer displacement restriction system that at least partly overcome the drawbacks and risks mentioned above.

These and other objects may be provided for by a drawer displacement restriction system, wherein the system comprises:
at least two drawers, each drawer having a rear panel connecting with two opposing side panels;
at least two pairs of wire guiding members, each pair being configured to be supported by a wall of the chest of drawers in a position adjacent a respective drawer;
a wire being configured to extend along a wall of the chest of drawers and through a channel in each wire guiding member in the at least two pairs of wire guiding members; and
at least two pulling members, wherein each of the at least two drawers is configured support a respective pulling member; wherein
one of the at least two pulling members is configured to selectively engage the wire in a position between two wire guiding members in a pair of wire guiding members during opening of a drawer associated with said pulling member.

Accordingly, a drawer displacement restriction system is provided in which the at least two pairs of wire guiding members are interconnected via a wire that extends through a channel in each and one of the wire guiding members. Thereby a highly simplified mounting process is provided for, wherein the user may receive the wire and the at least two pairs of wire guiding members as one single aggregate. During assembly of the chest of drawers, the user may mount the respective wire guiding members at dedicated positions represented by patterns of pre-formed recesses in a wall, such as a side wall or even the rear wall, of the chest of drawers in the very same way as is normally made when assembling a chest of drawers of the self-assembly type. During this process, the wire and the at least two pairs of wire guiding members will automatically be oriented into their intended working positions. Alternatively, the wire and the at least two pairs of wire guiding members may be delivered pre-mounted to the side wall or rear wall of the chest of drawers.

In the event the wire guiding members are used to interconnect the side wall and the rear wall, the wire guiding members will serve a dual purpose. Firstly, they guide the wire which as such is essential for the drawer displacement restriction system to operate. Secondly, they are a part of the locking system that is used to mount the rear wall to the side wall. If the wire guiding members are not mounted, the rear wall will be loose. Accordingly, the aggregate with the wire and the wire guiding members slidingly mounted to the wire will force the user of the furniture to mount the aggregate, unless not delivered pre-mounted, to have a chest of drawers that operates properly.

The wire may be configured to extend along one of two opposing side walls of the chest of drawers, and each pair of wire guiding members may be configured to be supported by the same side wall of the two opposing side walls of the chest of drawers. In another embodiment, wire may be configured to extend along the rear wall of the chest of drawers, and each pair of wire guiding members may be configured to be supported by the rear wall or by one of the two opposing side walls of the chest of drawers.

The pulling member may be an integral part of an interconnection member configured to interconnect a side panel of the drawer with a rear panel of the drawer. Thereby it is ensured that the pulling member is mounted during the assembly of the drawer and it is prevented that the user deliberately omits the mounting of the pulling member to thereby set aside the intended safety function of the drawer displacement restriction system. As yet another advantage, by integrating the pulling member with the interconnection member configured to interconnect a side panel of the drawer with a rear panel of the drawer, the number of article numbers may be reduced.

The pulling member may be provided with a bevel in its rear end so that it easily can pass the wire when inserting the drawer for the first time.

The pulling member may comprise a protrusion configured to be inserted into a though going opening in the side panel of the drawer and into a recess in an edge surface of the rear panel of the drawer. The protrusion thereby serves as a plug that extends through the side panel of the drawer and into the edge surface of the rear panel of the drawer. The protrusion is preferably provided with a through-going channel configured to receive a screw. The screw may in turn be configured to lockingly engage a locking nut arranged in the rear wall of the drawer.

The pulling member may comprise a hook, and the pulling member may be configured to selectively engage the wire by means of said hook.

A rear end of the hook may be provided with a bevelled shape so that the pulling member easily can pass the wire when inserting the drawer for the first time. Thereby, the hook will be ready to catch the wire as the drawer is opened.

The wire may have a length such that the drawer displacement restriction system allows either one drawer only to be fully opened, or two or more drawers to be only partly opened. This is a safety measure that restricts the displacement of the center of gravity to such extent that the chest of drawers is prevented, or at least substantially prevented, from tipping over. This effect is provided for since the length of the wire restricts the number of drawers that may be opened simultaneously. All drawers in the chest of drawers share a common wire and the total length of the wire is adapted to allow, either one drawer to be fully opened or two or more drawers to be only partly opened at one and the same time. This can be freely controlled by the user at her own choice.

The drawer displacement restriction system may further comprise: a first connector configured to be attached to a first end of the wire, the first connector being configured to be attached to a wall of the chest of drawers at a first position; and a stopper configured to be attached to a second end of the wire.

At least one of the first connector and the stopper may comprise a biasing member configured to exert a pulling force to the wire along the longitudinal extension of the wire.

The biasing member contributes to close a drawer when the drawer is set to an opened, or partially opened position. It is though preferred that the biasing force is lower than the force that is required to be applied to a drawer in order to overcome the frictional engagement to displace the same from an opened or partially opened position to a closed position. However, once the frictional force has been overruled and the drawer has started to move towards its closed position, the biasing force will positively contribute to the displacement of the drawer. The biasing member may in one embodiment be a spring biased pulley. Such spring biased pulleys are by way of example well known from key holders and card holders. The biasing member may in another embodiment be a counterweight connected to a free end of the wire. The biasing member may in yet another embodiment be an elastic member such as a spring or a rubber band.

The stopper may be a second connector configured to be attached to a wall of the chest of drawers at a second position, wherein the wire is configured to extend between the first and second positions and hence between the first and second connectors.

The first connector may be configured to be arranged at an upper end portion of a wall, such as a side wall, of the chest of drawers in a position above the upper most drawer, and the second connector may be arranged at a lower end portion of the same wall of the chest of drawers in a position below the lower most drawers. Alternatively, the second connector may be configured to be arranged at an end portion of a wall, such as a side wall, of the chest of drawers in a position above the upper most drawer, and the first connector may be arranged at a lower end portion of the same wall of the chest of drawers in a position below the lower most drawers.

The two connectors may be arranged along a vertical line but may also be arranged along a line forming an angle to a vertical line.

The first and second connectors are preferably arranged along one of the two opposing side walls of the chest of drawers but may by way of example with remained function be arranged on an inner surface of the rear wall of the chest of drawers. No matter position it is preferred that the first and second connectors are arranged in positions above the upper most drawer and below the lower most drawer.

The wire may be non-flexible along its longitudinal extension and bendable relative to its longitudinal extension. The wire may by way of example be a single or multi-stranded metal wire or a woven ribbon.

The channel in each wire guiding member may comprise an inlet opening, an outlet opening and an envelope surface extending between the inlet and outlet openings, and the envelope surface may comprise a straight first wall portion and a single-curved second wall portion opposite the straight first wall portion, and the wire may be configured to be forced by the pulling member towards and into abutment with the single-curved wall portion during opening of a drawer.

The single-curved second wall portion is preferably arranged closest to the respective drawer as seen in a condition when the wire guiding member is mounted to the chest of drawers. By the single-curved extension, the wear on the wire may be substantially reduced over time.

The wire guiding member may comprise a first protrusion configured to be received in a recess in a side wall of the chest of drawers, and a second protrusion configured to be received in a recess that partially overlaps a groove configured to receive a rear wall of the chest of drawers. The two connection portions allow a simple and secure anchoring of the respective wire guiding member to the chest of drawers. Also, the second protrusion provides a locking effect, locking the rear wall of the chest of drawers to a side wall thereof. This means that if the wire guiding members are not properly mounted, the chest of drawers will not work as intended and the rear wall will be loose. The second connection portion may have a flexible profile configured to receive an optional expansion member, such as a wedge, to further improve a locking effect.

According to another aspect, a chest of drawers is provided. The chest of drawers comprises a first and a second side wall opposing each other, at least two drawers, each drawer having a rear panel connecting with two opposing side panels, and a drawer displacement restriction system, wherein the drawer displacement restriction system comprises:
at least two pairs of wire guiding members, each pair being supported by a wall of the chest of drawers in a position adjacent a respective drawer;
a wire extending along a wall of the chest of drawers and through a channel in each wire guiding member in the at least two pairs of wire guiding members; and
a pulling member connected to each of the at least two drawers; wherein
the pulling member of a respective drawer is configured to selectively engage the wire in a position between two wire guiding members in a pair of wire guiding members during opening of said drawer.

The design, operation and advantages of the drawer displacement restriction system have been thoroughly discussed above. These arguments are equally applicable to a chest of drawers using such system. Hence, in order of avoiding undue repetition, reference is made to the sections given above.

According to yet another aspect, an aggregate to be used in a drawer displacement system according to any of claims 1-11 is provided. Said aggregate comprises: at least two pairs of wire guiding members, each wire guiding member comprising a through-going channel; a wire extending through the channel of each wire guiding member; a first connector attached to a first end of the wire; and a stopper or second connector attached to a second end of the wire.

The aggregate may be provided as one single article and facilitate assembly and stock keeping.

According to another aspect, the objects may also be provided for by a second embodiment of a drawer displacement restriction system, which system comprises:
at least two chest guiding rails, each chest guiding rail being configured to be fixedly connected to a first side wall of a chest of drawers, and each chest guiding rail being configured to guide a drawer guiding rail of a respective drawer;
a wire configured to extend along a wall of the chest of drawers;
at least two pulling members, each pulling member being configured to be fixedly arranged to a respective drawer and to selectively interact with the wire; and
wherein the wire is configured to extend through a respective loop in each of the at least two chest guiding rails.

Accordingly, a drawer displacement restriction system is provided in which the at least two chest guiding rails are interconnected via a wire that extends through a respective loop in each and one of the two chest guiding rails. Thereby a highly simplified mounting process is provided for, wherein the user may receive the wire and the at least two chest guiding rails as one single aggregate. During assembly of the chest of drawers, the user may mount the respective chest guiding rails to dedicated positions represented by patterns of pre-formed recesses in the first side wall of the chest of drawers in the very same way as is normally made when assembling a chest of drawers of the self-assembly type. During this process, the wire will automatically be oriented into its intended position. Alternatively, the wire and the at least two chest guiding rails may be delivered pre-mounted to the side wall of the chest of drawers. By the wire being delivered in a condition where the wire extends through a respective loop in each of the at least two chest guiding rails, any person who would like to set aside the function of the wire, must deliberately remove e.g., by cutting, the wire. It is to be stressed that the free ends of the wire must not be mounted to the same wall as the chest guiding rails.

The wire may have a length such that the drawer displacement restriction system allows either one drawer only to be fully opened, or two or more drawers to be only partly opened.

This is a safety measure that restricts the displacement of the center of gravity to such extent that the chest of drawers is prevented, or at least substantially prevented, from tipping over. This effect is provided for since the length of the wire restricts the number of drawers that may be opened simultaneously. All drawers in the chest of drawers share a common wire and the total length of the wire is adapted to allow, either one drawer to be fully opened or two or more drawers to be only partly opened at one and the same time. This can be freely controlled by the user at her own choice.

Each chest guiding rail may, in an end configured to face a rear wall of the chest of drawers, comprise a wire guide member, and the loop may be formed by said wire guide member.

The wire guide member forms a diverting surface around which the wire is forced to temporarily change its longitudinal direction during opening of the specific drawer.

Each chest guiding rail may in an end configured to face a rear wall of the chest of drawers comprise two wire guide members, each wire guide member comprising a loop, and wherein the wire is configured to extend through both loops.

The pulling member of each drawer may be arranged in a position on the drawer in which it is allowed to pass between the two wire guide members during opening of the drawer. Depending on the design of the chest guiding rail, which is in some embodiments at least partly may encircle the drawer guiding rail as seen along the longitudinal extension of the two rails, the wire will be pulled along the interior of the chest guiding rail as the drawer is opened. This is the result of the wire guide member with its loop being connected to the drawer guiding rail and the wire extending through said loop. In this manner, the wire is protected from getting entangled with any foreign items during opening/closing of the drawer.

The pulling member may be an integral part of an interconnection member that is configured to interconnect a side wall of the drawer with a rear wall of the drawer. By arranging the pulling member as an integral part of an interconnection member, it is ensured that the pulling member is mounted during the assembly of the drawer. Thereby it is prevented that the user deliberately omits the mounting of the pulling member to thereby set aside the intended safe function of the drawer displacement restriction system.

As yet another advantage, by integrating the pulling member with the interconnection member that is configured to interconnect a side wall of the drawer with a rear wall of the drawer, the number of article numbers may be reduced.

The interconnection member may comprise a protrusion that is configured to be inserted into a though-going opening in the side wall of the drawer and into a recess in an edge surface of the rear wall of the drawer. The protrusion thereby serves as a plug that extends through the side wall of the drawer and into the edge surface of the rear wall of the drawer. The protrusion is preferably provided with a through-going channel configured to receive a screw. The screw may in turn be configured to lockingly engage a locking nut arranged in the rear wall of the drawer.

The drawer displacement restriction system may further comprise:
a first connector configured to be attached to a first end of the wire, the first connector being configured to be attached to a wall of the chest of drawers at a first position; and
a second connector configured to be attached to a second end of the wire, the second connector being configured to be attached to a wall of the chest of drawers at a second position; wherein the wire is configured to extend between the first and second positions.

Accordingly, the wire may be configured to be mounted to the side wall of the chest of drawers, not only by the at least to chest guiding rails but also by a first and a second connector. The first connector may be arranged at an upper end portion of the side wall of the chest of drawers in a position above the upper most drawer, and the second connector may be arranged at a lower end portion of the same side wall of the chest of drawers in a position below the lower most drawers. The two connectors may be arranged along a vertical line but may also be arranged along a line forming an angle to a vertical line. It is also to be understood that the first and second connectors must not be arranged at the same wall of the chest of drawers as the chest guiding rails. The first and second connectors may by way of example be arranged on an inner surface of the rear wall of the chest of drawers. No matter position it is though preferred that the first and second connectors are arranged in positions above the upper most drawer and below the lower most drawer.

At least one of the first and second connectors may comprise a biasing member configured to exert a pulling force to the wire along the longitudinal extension of the wire. The biasing member contributes to close a drawer when the drawer is set to an opened, or partially opened position. It is though preferred that the biasing force is lower than the force that is required to be applied to a drawer in order to overcome the frictional engagement to displace the same from an opened or partially opened position to a closed position. However, once the frictional force has been overruled and the drawer has started to move towards its closed position, the biasing force will positively contribute to the displacement of the drawer.

The biasing member may in one embodiment be a spring biased pulley. Such spring biased pulleys are by way of example well known from key holders and card holders. The biasing member may in another embodiment be a counterweight connected to a free end of the wire. The biasing member may in yet another embodiment be an elastic member such as a spring or a rubber band.

The wire may be non-flexible along its longitudinal extension and bendable relative to its longitudinal extension. The wire may by way of example be a single or multi-stranded metal wire or a woven ribbon.

According to another aspect, a chest of drawers is provided. The chest of drawer comprises a first and a second side wall opposing each other, at least two drawers, and a drawer displacement restriction system, wherein the drawer displacement restriction system comprises:
at least two chest guiding rails fixedly connected to the first side wall of the chest of drawers, each chest guiding rail being configured to guide a drawer guiding rail of a respective drawer;
a wire extending along a wall of the chest of drawers;
at least two pulling members, each pulling member being fixedly arranged to a respective drawer and being configured to selectively interact with the wire during pulling out of one or more of the at least two drawers; and
wherein the wire extends through a respective loop in each of the at least two chest guiding rails.

The design, operation and advantages of the drawer displacement restriction system has been thoroughly discussed above. These arguments are equally applicable to a chest of drawers using such system. Hence, in order of avoiding undue repetition, reference is made to the sections given above.

Further objects and advantages of the present inventions, no matter if it refers to the first or second embodiments of the drawer displacement restriction systems will be obvious to a person skilled in the art reading the detailed description given below describing different embodiments.

### BRIEF DESCRIPTION OF THE DRAWINGS

The inventions will now be described in detail with reference to the schematic drawings.

FIG. 1 is a first schematic perspective view of a chest of drawers implemented with a first embodiment of the drawer displacement restriction system according to the invention FIG. 2a is a first schematic view of an aggregate comprising a wire and a plurality of wire guiding members to be used in the drawer displacement restriction system according to the first embodiment.

FIG. 2b is a first schematic view of the aggregate of FIG. 2b where the wire is subjected to a pulling force before mounting to a chest of drawers.

FIG. 3 schematically discloses the mounting of the aggregate to the inner wall of a chest of drawers.

FIG. 4 schematically discloses the mounting of a rear wall to the chest of drawers.

FIG. 5 schematically discloses the assembly of a drawer by using a pulling member as an integrated locking member.

FIG. 6 is a perspective view of a wire guiding member.

FIG. 7 discloses a schematic cross section of the wire guiding member.

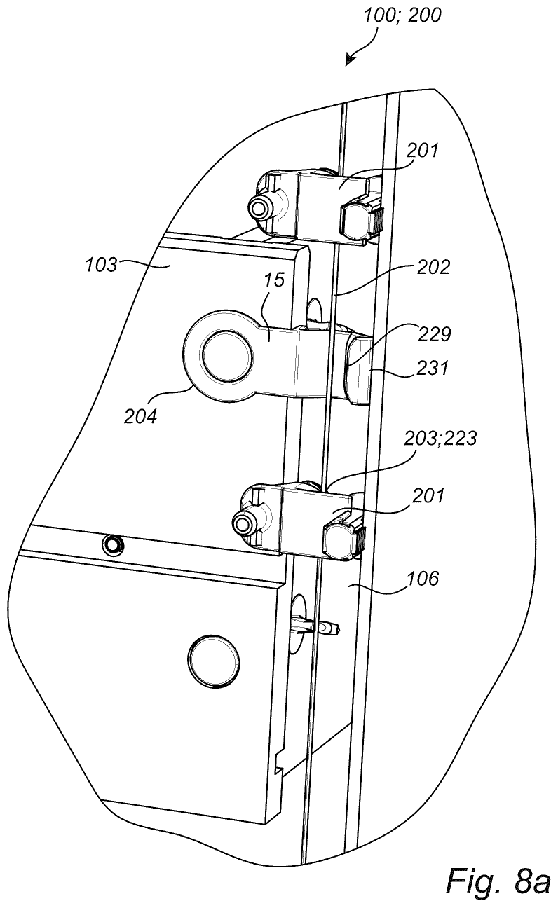

FIGS. 8a-8b disclose the operation of the drawer displacement restriction system.

FIG. 9a schematically discloses the operation of the drawer displacement restriction system according to the first embodiment during the opening of a single drawer.

FIG. 9b schematically discloses the operation of the drawer displacement restriction system according to the first embodiment during opening of two drawers simultaneously.

FIG. 10 is a first schematic perspective view of a chest of drawers implemented with a second embodiment of the drawer displacement restriction system.

FIG. 11 is a schematic overview of the interconnection between a chest guiding rail and the wire.

FIG. 12 is a schematic perspective view of the wire as mounted to a chest guiding rail.

FIG. 13 is a schematic overview of the interface between the wire and a pulling member and a drawer.

FIG. 14 disclose the interaction between the wire and the pulling member during opening of a drawer.

FIG. 15 schematically discloses the operation of the drawer displacement restriction system according to the second embodiment during the opening of a single drawer.

FIG. 16 schematically discloses the operation of the drawer displacement restriction system according to the second embodiment during opening of two drawers simultaneously.

### DETAILED DESCRIPTION

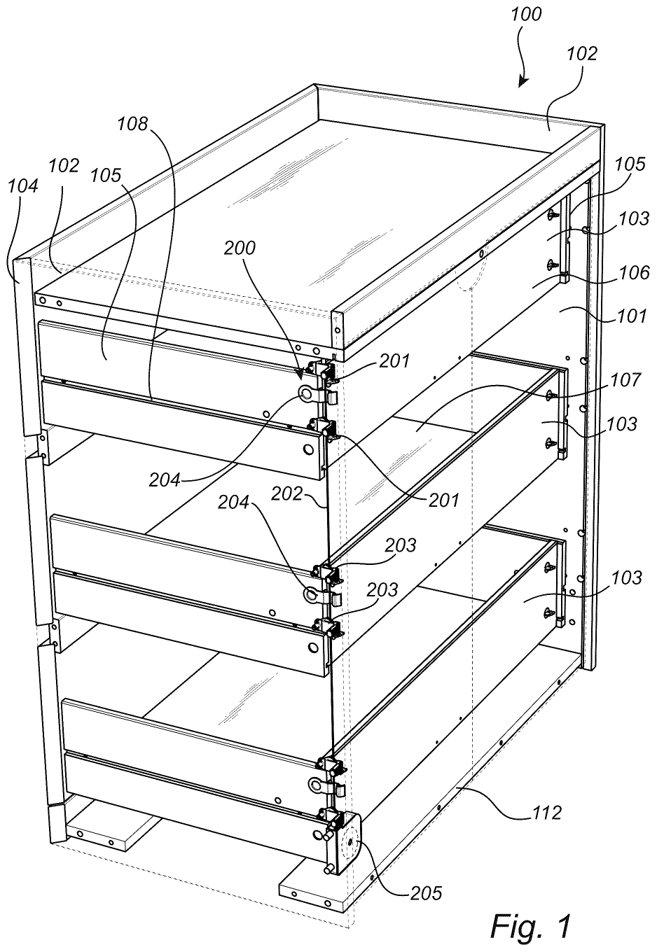

Starting with FIG. 1, a schematic perspective view of a chest of drawer 100 is illustrated with an implemented drawer displacement restriction system 200 according to a first embodiment of the invention.

The rear wall 101 and one of the two opposing side walls 102 of the chest of drawers 100 are disclosed with dashed lines to facilitate understanding. The chest of drawer 100 is illustrated with three drawers 103. It is to be understood that the chest of drawers 100 with remained function may have two or more drawers 103. It is also to be understood that the drawers 103 must not have the same height.

Each drawer 103, which as such is well known in the art, comprises a front panel 104, two opposing side panels 105 and a rear panel 106. Further, the drawer comprises 103 a bottom panel 107 that extends between the side panels 105, the front panel 104 and the rear panel 106. The rear panel 106 extends between and has two opposing end edges abutting the inner wall portions of the first and second side panels 105. The two side panels 105 are identical whereby only one will be discussed below.

The front panel 104, the two opposing side panels 105, the rear panel 106 and the bottom panel 107 may be connected to each other in a number of ways which as such are well known in the art. The connection may by way of example be made by one or more of screws, plugs, nails, friction and adhesive.

Each of the two opposing side panels 105 of the drawer 103 comprises, on the exterior wall portions thereof, a drawer guiding rail 108. Each drawer guiding rail 108 is configured to be slidingly received in a respective chest guiding rail (not illustrated) in a manner well known in the art. The respective chest guiding rails may be fixedly mounted to or be integrally formed with the two opposing inner wall portions of the two opposing side walls 102 of the chest of drawers 100.

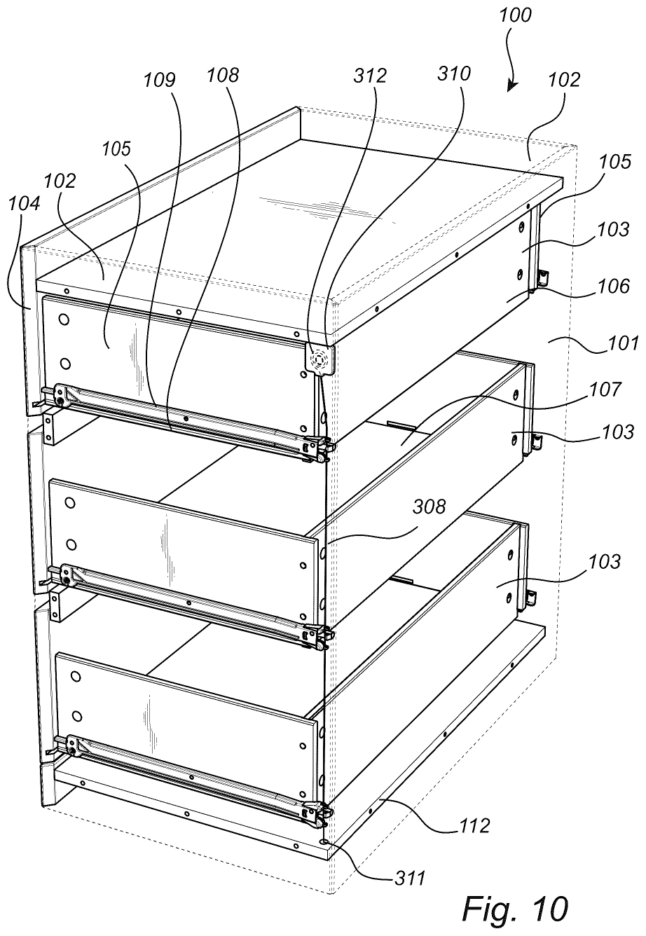

The drawer guiding rails 108 and the chest guiding rails may be of any type suitable to provide a proper guiding of a drawer during its opening and closing. The drawer guiding rails 108 may in their easiest form be longitudinally extending slots configured to interact with corresponding protruding rails on the opposing inner side wall portions of the two opposing side walls 102 of the chest of drawers 100. Other well-known examples of guiding rails are the so-called roller guiding rails. One such example is shown in FIG. 10. The drawer displacement restriction system 200 according to the first embodiment of the invention may be implemented no matter type of guiding system for the drawers.

The chest of drawers 100 is provided with a drawer displacement restriction system 200 that is arranged along one of the two opposing side walls 102 of the chest of drawers.

The drawer displacement restriction system 200 according to the first embodiment comprises two pairs of wire guiding members 201 per drawer. The number of pairs correspond to the number of drawers 103. Each pair is supported by one of the two opposing inner wall portions of the side walls 102 of the chest of drawers 100 in a position adjacent a respective drawer 103. The drawer displacement restriction system 100 further comprises a wire 202 that extends along the side wall 102 of the chest of drawers 100 and through a channel 203 in each wire guiding member 201. The drawer displacement restriction system 200 further comprises at least two pulling members 204. Each drawer 103 supports a respective pulling member 204. Each pulling member 204 is configured to selectively engage the wire 202 in a position between two wire guiding members 201 in a pair of wire guiding members 201 of an associated drawer 103 during opening of the drawer.

The wire 202 and the wire guiding members 201 are disclosed as being supported by the side wall 102 of the chest of drawers 103 that is closest to the side panels 105 of the drawers 103 that supports the pulling members 204.

The wire 202 is connected to the inner side wall 102 of the chest of drawers 100 at least by a first connector 205 and by the plurality of wire guiding members 201. The first connector 205 is disclosed as being connected to a lower rear corner of the side wall 102. The skilled person realises that the first connector 205 with remained function may be connected to an upper rear corner of the side wall 102. Alternatively, the first connector can be connected to the rear wall of the chest of drawers 100.

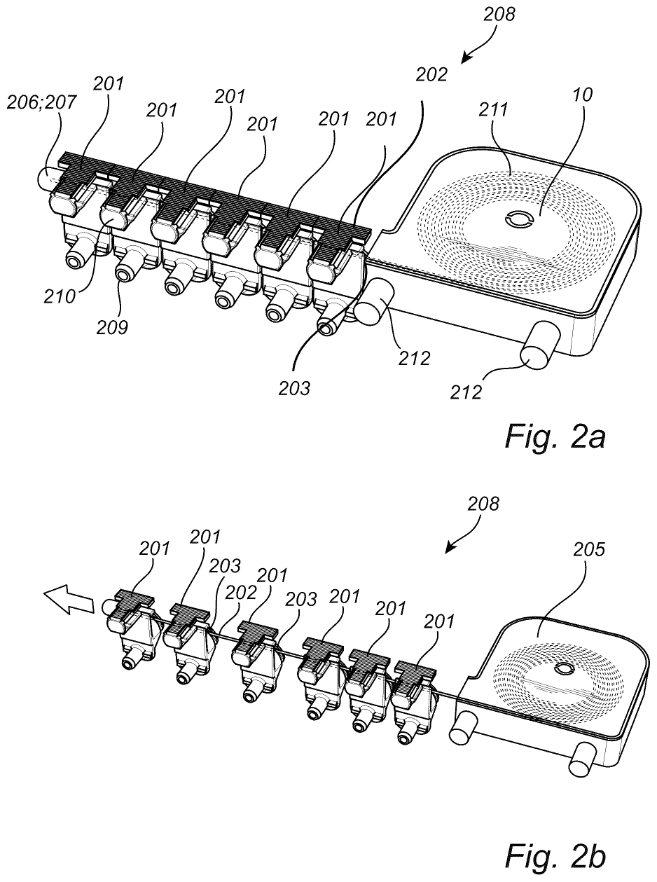

The wire 202, the plurality of wire guiding members 201, the first connector 205, a stopper 206 or second connector 207 may be provided as one aggregate 208. Turning to FIGS. 2a and 2b, one embodiment of such aggregate 208 forming part of the drawer displacement restriction system 200 according to the first embodiment of the invention is disclosed.

The aggregate 208 comprises at least two pairs of wire guiding members 201 that are threaded on the wire 202. The number of pairs corresponds to the number of drawers 103 in the chest of drawers 100. Each wire guiding member 201 comprises two protrusions, forming a front end protrusion 209 and a rear end protrusion 210. The two protrusions 209, 210 are configured to be fixedly connected to corresponding recesses in the inner side wall 102 of the chest of drawers 100. This will be further discussed below.

The wire 202 extends through a through-going channel 203 of each wire guiding member 201. The wire 202 may be non-flexible along its longitudinal extension and bendable relative to its longitudinal extension. The wire 202 may by way of example be a single or multi-stranded metal wire or a woven ribbon.

A first end of the wire 202 is connected the first connector 205 and the second end of the wire is connected to the stopper 206. The first connector 205 is disclosed as being a biasing member 211 configured to exert a pulling force to the wire 202 along its longitudinal extension. The biasing member 211 may in one embodiment be a spring biased pulley. Such spring biased pulleys are well known from by way of example key holders and card holders.

The first connector 205 comprises two protrusions 212 configured to be fixedly connected in corresponding recesses in the side wall 102 of the chest of drawers. This will be further discussed below.

The stopper 206 is disclosed as a body that prevents the wire guiding members 201 from falling off the wire 202. In an alternative, non-illustrated embodiment, the stopper 206 may be provided as a second connector 207 with at least one protrusion (not illustrated) that is configured to be fixedly connected to the side wall 102 of the chest of drawer 100. No matter if it is a stopper or a second connector, the stopper/connector will be arranged in a position on the chest of drawers 100 that is different from the position of the first connector 205 when the aggregate 208 is mounted to the chest of drawers 100.

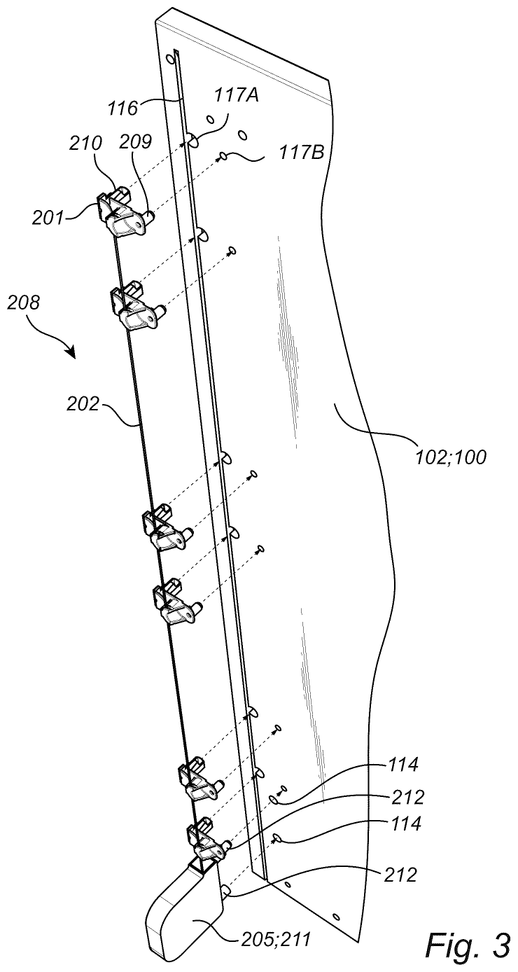

Now turning to FIG. 3, the mounting of the aggregate 208 to the inner side wall 102 of the chest of drawers 100 is illustrated. The protrusions 209, 210, 212 of the respective wire guiding members 201 and the first connector 205 are forced into corresponding recesses 114, 117A, 117B in the inner side wall 102. The protrusions 209, 210, 212 may be fixed to the respective recesses 114, 117A, 117B by friction only, by adhesive or by a combination of friction and adhesive. The skilled person realises that the components with remained functionality may be fixated by other means as well, such as screws. The aggregate 208 is arranged in a straight-linear fashion along the inner side wall of the chest of drawers.

The connectors 209, 210, 212 of the wire guiding members 201 and the first connector 205 respectively are accordingly configured to be mounted to dedicated positions represented by patterns of pre-formed recesses 114, 117A, 117B in the first side wall 102 of the chest of drawers 100. During this process, the wire 8 will automatically be pulled out from the biasing member 211 of the first connector 205 while also being oriented into its intended position.

Alternatively, the aggregate 208 may be delivered pre-mounted to the side wall 102 of the chest of drawers 100.

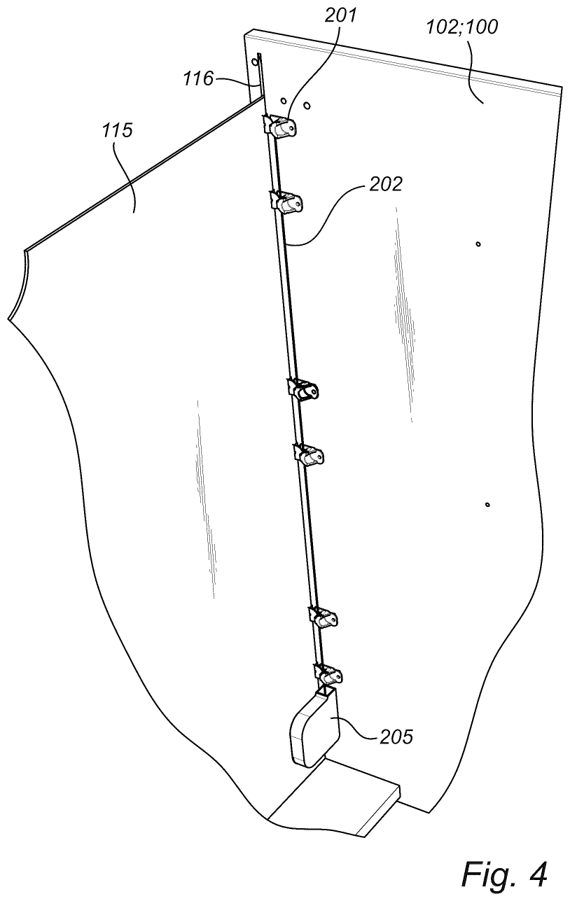

Now turning to FIG. 4. After mounting of the aggregate 208 to the inner side wall 102 of the chest of drawers 100, a rear wall 115 of the chest of drawers 100 is mounted. The rear wall 115 is disclosed as being guided along an associated groove 116 having an extension along the two opposing side walls 102 (only one illustrated).

As is best seen in FIG. 3, one of the two openings 117A for each wire guiding member 201 partially overlaps the longitudinally extending groove 116. When mounting the wire guiding members 201 to the side walls, the second protrusion 210 will abut the rear wall 115 and thereby contribute to keeping the rear wall 115 in position in the groove 116. Accordingly, the wire guiding members 201 serves a dual purpose. Firstly, they guide the wire 8 which as such is essential for the drawer displacement restriction system to operate. Secondly, they are part of a locking system that is used to mount the rear wall 115 to the side wall 102. If the wire guiding members are not mounted, the rear wall 115 will be loose. Accordingly, the design of the aggregate 208 with the wire and the wire guiding members 201 slidingly mounted to the wire forces the user of the chest of drawers to mount the aggregate 208, unless not delivered pre-mounted, to have a chest of drawers that operates properly.

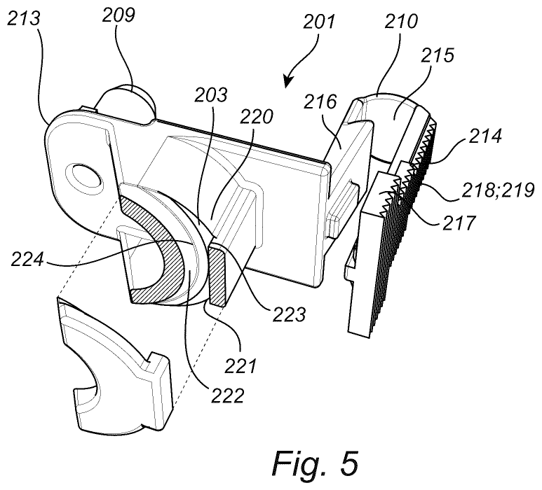

Now turning to FIG. 5, one embodiment of the wire guiding member 201 is disclosed. The wire guiding member 201 comprises a unitary body having a front end 213 configured to face a front end of the chest of drawers 100 and a rear end 214 configured to face the rear wall of the chest of drawers. The front end 213 comprises a first protrusion forming a front-end protrusion 209 that is configured to lockingly engage a corresponding recess 117A, 117B in the side wall 102 of the chest of drawers 100. The rear end comprises a second protrusion forming a rear-end protrusion 210 that is configured to lockingly engage a corresponding recess 117 in the side wall 102 of the chest of drawers 100.

The front-end protrusion 209 may have cylindrical axial extension. The front-end protrusion 209 is configured to be inserted to the associated recess 117B in the side wall 102 of the chest of drawers 100, see FIG. 3.

The rear-end protrusion 210 is provided with an axially extending recess 215 that divides the rear-end protrusion 210 into two opposing legs 216, 217 that provide the rear-end protrusion 210 with an inherent flexibility. The two legs 216, 217 may form a mutual angle, whereby a wedge-like locking effect may be achieved as the rear end protrusion 210 is inserted to the associated recess 117A in the side wall 102 of the chest of drawers 100.

The outer most leg 217 has an exterior flat surface 218 with an optional embossing 219. The embossing 219 is configured to enhance a frictional engagement with the rear wall 115 of the chest of drawers 100 when the rear end protrusion 210 is mounted to the associated recess 117A, see FIG. 4. The rear end protrusion 210 of the wire guiding member 201 may hence serve the dual purpose of fixating the wire guiding member 201 to the chest of drawers 100 and keeping the rear wall 115 of the chest of drawers 100 in position. To further increase the frictional engagement with the rear wall 115, it is preferred that a non-illustrated wedge is forced into the axially extending recess 215 when mounting the rear wall 115 to the chest of drawers 100. The wedge will force the two opposing legs 216, 217 apart and thereby strengthen the locking effect when the rear end protrusion 210 is inserted to the associated recess 117A in the side wall 102 of the chest of drawers 100.

The wire guiding member 201 further comprises the through-going channel 203. To better illustrate the geometry of the channel 203, a portion of the wire guiding member 201 is schematically removed. The channel 203 comprises an inlet opening 220, an outlet opening 221 and an envelope surface 222 extending between the inlet and outlet openings 220, 221. The envelope surface 222 comprises a straight first wall portion 223 and a single-curved second wall portion 224 opposite the straight first wall portion. The single-curved wall portion 224 is arranged adjacent the front end 213 of the wire guiding member 201, and hence closest to the respective drawer 103 as seen in a condition when mounted to the chest of drawers 100. As will be discussed below, as a drawer 103 is opened, the wire 202 will be forced by the pulling member 204 towards and into abutment with the single-curved wall portion 224.

The wire guiding member 201 may be formed by injection moulding a plastic material.

The skilled person realises that the wire guiding member 201 may be designed in a number of ways with remained functionality.

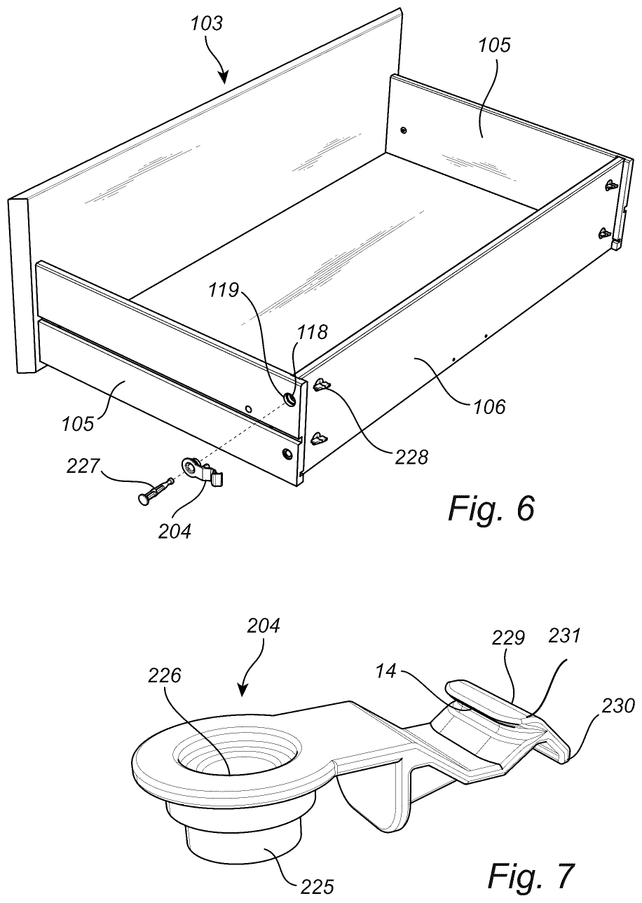

Now turning to FIGS. 5 and 6, the pulling member 204 and its interaction with a drawer 103 is illustrated. As will be seen from these illustrations, the pulling member 204 is in the disclosed embodiment constituted as an interconnection member configured to interconnect a side panel 105 of the drawer 103 with a rear panel 106 of the drawer. By arranging the pulling member 204 as an integral part of an interconnection member it is ensured that the pulling member 204 is mounted during the assembly of the drawer 103. Thereby it is prevented that the user deliberately omits the mounting of the pulling member 204 to thereby set aside the intended safety function of the drawer displacement restriction system 200.

The pulling member 204 comprises a protrusion 225 configured to be inserted into an associated though-going opening 119 in the side panel 105 of the drawer 103 and into a mating recess 118 in an edge surface of the rear panel 106 of the drawer 103. The protrusion 225 thereby serves as a plug that extends through the side panel 105 of the drawer and into the edge surface of the rear panel 106 of the drawer. The protrusion 225 is preferably provided with a through-going channel 226 configured to receive a screw 227. The screw 227 may in turn be configured to lockingly engage a locking nut 228 arranged in the rear wall 106 of the drawer 103.

The pulling member 204 further comprises a hook 229. As will be better described below, the pulling member 204 is configured to selectively engage the wire 202 by means of said hook 228.

An outer wall portion adjacent the hook comprises a bevelled surface 231. The bevelled surface 231 will be discussed below.

The wire guiding member may be formed by injection moulding a plastic material. The skilled person realises that the wire guiding member pulling member 204 may be designed in a number of ways with remained functionality.

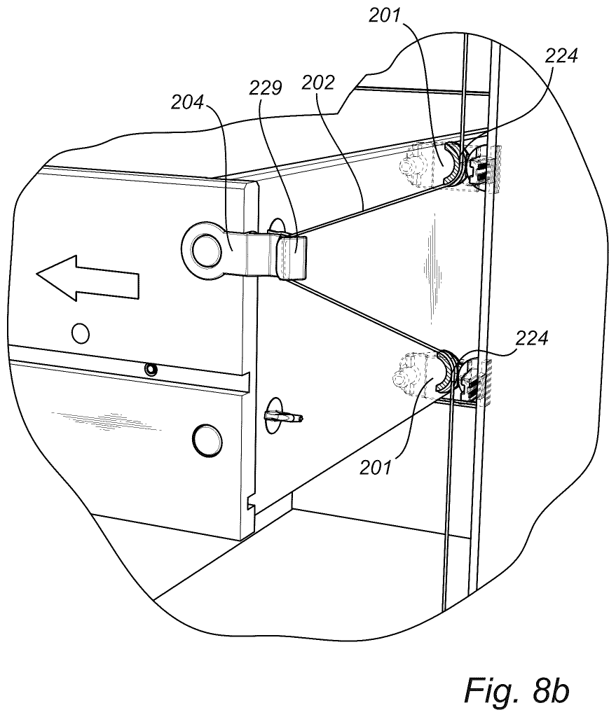

Now turning to FIGS. 8a and 8b the general operation principle of the drawer displacement restriction system 200 according to the first embodiment of the invention is illustrated. To facilitate understanding, the side wall of the chest of drawers 100 is omitted.

As previously discussed, the drawer 103 supports a pulling member 204 that is arranged in a position between two wire guiding members 201 that are associated with the drawer 103.

FIG. 8a discloses the drawer 103 when it is fully closed. The wire 202 extends through the respective through-going channels 203 of the wire guiding members 201. The wire 202 has a substantially vertical extension in parallel with the straight linear wall portion 223 of the through-going channel 203. Further, the wire 202 extends along an interspace between the hook 229 and the rear panel 106 of the drawer 103. In this position, there is preferably no contact between the wire 202 and the pulling member 204 and preferably also no contact between the wire 202 and the wire guiding member 201.

As mentioned above, an outer wall portion adjacent the hook 229 comprises a bevelled surface 231. The purpose of this bevel is to facilitate insertion of the drawer 103 into the chest of drawers 100 during assembly of the latter. By the bevel 231, the wire 202, that has an inherent tension, will smoothly be forced to be guided past a free end 230 of the pulling member 204 and then flex back into a linear condition where it is allowed to be engaged by the hook 229 during pulling of the drawer 103.

Now turning to FIG. 8b, the opening of the drawer 103 is initiated, see arrow. The hook 229 of the pulling member 204 engages the wire 202 and pulls the same in the drawer's opening direction. While doing so, the wire 202 is forced into engagement with the single-curved wall portions 224 of the two associated wire guiding members 201. The single-curved portions 224 do accordingly form diverting surfaces around which the wire 202 is forced to temporarily change its longitudinal direction during opening of the specific drawer 103. This reduces the wear on the wire 202 over time.

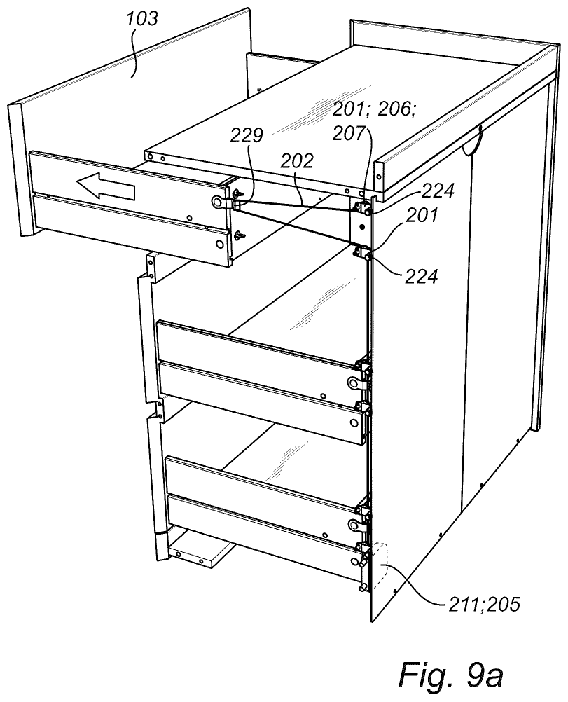

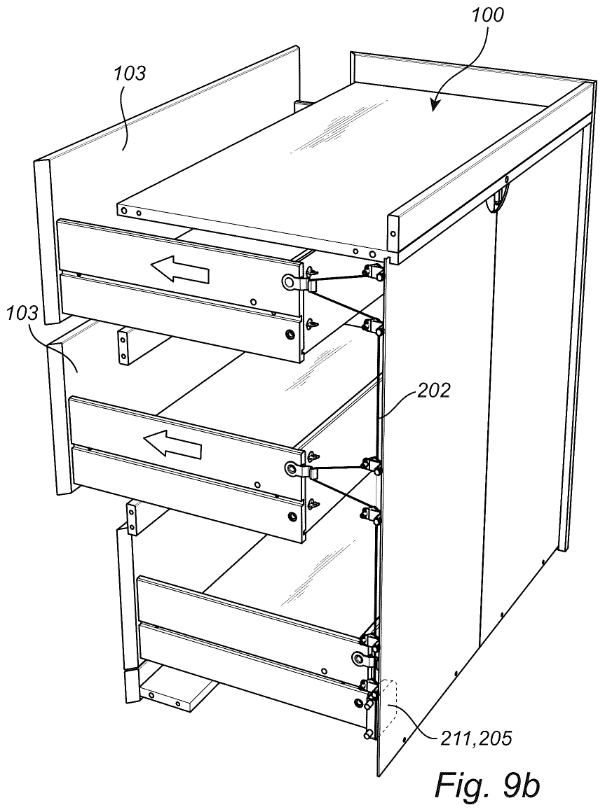

Now turning to FIG. 9a, the upper most drawer 103 is disclosed as being pulled to open the same, see arrow. As the drawer 103 is pulled, the hook 229 will engage and pull the wire 202 and hence force the same into an engagement with the single-curved surfaces 224 of its two associated wire guiding members 201.

The wire 202, which as such is non-flexible along its longitudinal extension, will be allowed by the biasing member 211 to be pulled along to such extent that the drawer 103 can be fully opened. The wire 202 has an available length such that the drawer displacement restriction system 200 allows either one drawer 103 only to be fully opened, or two or more drawers 103 to be only partly opened, see FIG. 9b. In the context of the first embodiment of the drawer displacement restriction system, the “available length” is to be understood as the sum of the distance between the first connector 205 and the stopper or second connector 206, 207 as seen in a condition when the aggregate is 208 is mounted to the side wall 102 of the chest of drawers and the extra wire length that may be provided by the pulling member 204 pulling the wire 202. The extra wire length provided by the pulling member 204 may be provided as a length being wound on a pulley of the biasing member 211, available displacement of a movable counterweight, or by elastically stretching the wire 202 as the pulling member 204 pulls the wire 202 during opening of one or more drawers 103. The available length of the wire 202 is dimensioned so that the number of drawers 103 that may be opened simultaneously is restricted. This is a safety measure that restricts the displacement of the center of gravity to such extent that the chest of drawers 100 is prevented, or at least substantially stopped, from tipping over.

Now turning to FIG. 9b, a situation is disclosed where two drawers 103 are opened simultaneously. All drawers 103 in the chest of drawers 100 share the common wire 202 and the available length of the wire 202 is adapted to allow, either one drawer 103 to be fully opened (as is disclosed in FIG. 9a) or two or more drawers 103 to be only partly opened at one and the same time. Thus, even though two drawers 103 are disclosed as being opened halfway, the same principle applies if more than two drawers 103 should be opened at the same time. The only difference will then be to which extent the number of drawers 103 may be opened. Also, it should be stressed that the drawers 103 can be opened to mutually different extents.

As discussed above, the first connector 205 comprises a biasing member 211 configured to exert a pulling force to the wire 202 along the longitudinal extension of the wire 202. The biasing member 211 contributes to close a drawer 103 when being set to an opened, or partially opened position. It is though preferred that the biasing force is lower than the force that is required to be applied to a drawer 103 in order to overcome the frictional engagement to displace the same from an opened or partially opened position to a closed position. However, once the frictional force has been overruled and the drawer 103 has started to move towards its closed position, the biasing force will positively contribute to the displacement of the drawer 103.

Accordingly, one embodiment a drawer displacement restriction system 200 is provided in which the at least two pairs of wire guiding members 201 are interconnected via a wire 202 that extends through a channel 203 in each and one of the wire guiding members 201. Thereby a highly simplified mounting process is provided for, wherein the user may receive the wire 202 and the at least two pairs of wire guiding members 201 as one single aggregate 208. During assembly of the chest of drawers 100, the user may mount the respective wire guiding members 201 at dedicated positions represented by patterns of pre-formed recesses in a wall, such as a side wall, of the chest of drawers. During this process, the wire 202 and the at least two pairs of wire guiding members 201 will automatically be oriented into their intended positions. The wire guiding members 201 may additionally provide a locking function where the rear wall 115 of the chest of drawers 100 is locked to a side wall 102 of the chest of drawers. Alternatively, the wire 202 and the at least two pairs of wire guiding members 201 may be delivered pre-mounted to the side wall 102 of the chest of drawers 100.

The drawer displacement restriction system 200 has been exemplified as being applied to a chest of drawers 100. It is to be understood that the system is equally applicable to other types of furniture with drawers where the center of gravity may be changed during use. Non-limiting examples are office furniture and file cabinets.

Now turning to FIG. 10, a schematic perspective view of a chest of drawer 100 is illustrated with an implemented drawer displacement restriction system 300 according to a second embodiment of the invention. The rear wall 101 and the two opposing side walls 102 of the chest of drawers 100 are disclosed with dashed line to facilitate understanding. The chest of drawer 100 is illustrated with three drawers 103. It is to be understood that the chest of drawers 100 with remained function may have two or more drawers 103. It is also to be understood that the drawers 103 must not have the same height.

Each drawer 103, which as such are well known in the art, comprises a front panel 104, two opposing side panels 105 and a rear panel 106. Further, the drawer comprises 103 a bottom panel 107 that extends between the side panels 105, the front panel 104 and the rear panel 106. The rear panel 106 extends between and has two opposing end edges abutting the inner wall portions of the first and second side panels 105. The two side panels 105 are identical whereby only one will be discussed below.

The front panel 104, the two opposing side panels 105, the rear panel 106 and the bottom panel 107 may be connected to each other in a number of ways which as such is well known in the art. The connection may by way of example be made by one or more of screws, plugs, nails, friction and adhesive.

Each of the two opposing side panels 105 of the drawer 103 comprises, on the exterior wall portions thereof, a drawer guiding rail 108. Each drawer guiding rail 108 is configured to be slidingly received in a respective chest guiding rail 109 in a manner well known in the art. The respective chest guiding rails 109 are fixedly mounted to two opposing inner wall portions of the two opposing side walls 102 of the chest of drawers 100.

The drawer guiding rails 108 and the chest guiding rails 109 are disclosed as being of the type where the drawer guiding rail 108, in an end thereof configured to face the rear wall 101 of the chest of drawers 103 comprises a wheel that is configured to be slidingly supported by and along the interior of its respective chest guiding rail 109. Further, said chest guiding rail 109 comprises in an end thereof configured to face the front panel 104 of the respective drawer 103, a wheel that is configured to slidingly engage the respective drawer guiding rail 108. Thereby, as the drawer 103 is pulled from a closed position towards an open position, or pushed from an open position towards a closed position, the wheels of the drawer guiding rail 108 and the chest guiding rail 109 will act as mutually displaced supports for the drawer 103. This is well known in the art and is not further discussed.

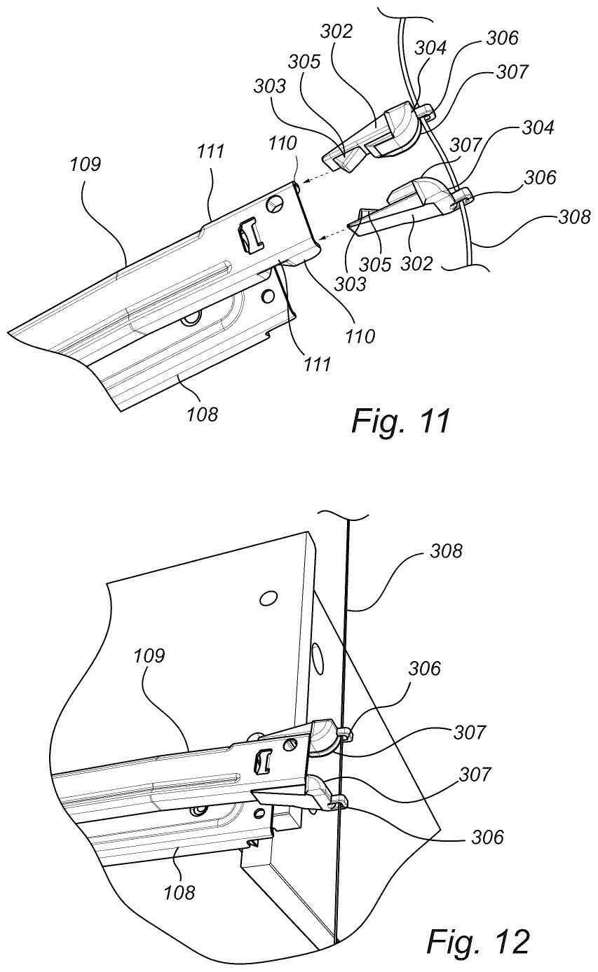

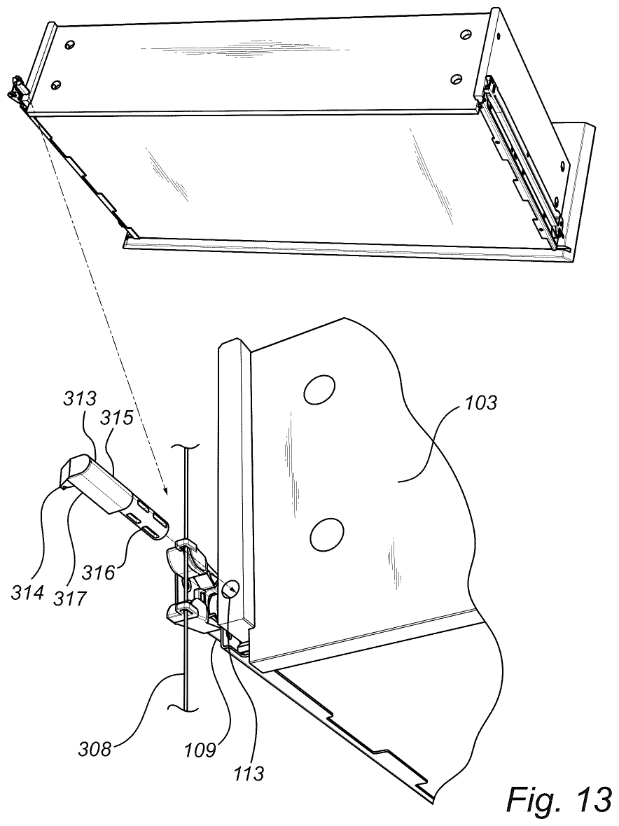

Now turning to FIGS. 11 and 12. FIGS. 11 and 12 disclose a rear end portion of a chest guiding rail 109. The rear end portion of the chest guiding rail 109 comprises a generally C-shaped cross section with two opposing flanges 110. The rear end portion of the chest guiding rail 109 is in the disclosed embodiment provided with two wire guide members 302. Each wire guide member 302 comprises a locking portion 303 and a wire guiding portion 304.

The locking portion 303 is configured to lockingly engage an exterior wall portion of one of the two opposing flanges of the C-shaped cross section of the chest guiding rail 109. The locking engagement is provided for by the locking portion 303 comprising a wedge-shaped protrusion 305 that is configured to lockingly engage a complementary recess 111 in the two flanges 110 of the C-shaped cross section of the chest guiding rail 109.

The wire guiding portion 304 comprises a loop 306 and a curved groove 307. The wire guiding portion 304 is configured to project away from the rear end of the chest guiding rail 109 in a condition when the wire guide member 302 is locked to the chest guiding rail 109. As is best seen in FIG. 12, the two curved grooves 307 of the two wire guide members 302 are configured to face each other in a condition when the two wire guide members 302 are mounted to the chest guiding rail 109.

As can be seen from FIGS. 11 and 12, a wire 308, to be described below, extends through the two loops 306.

Now turning to FIG. 10 anew. The inner wall of one of the two opposing side walls 102 of the chest of drawers 103 comprises a first connector 310 and a second connector 311, which connectors in turn are connecting to the ends of a wire 308. The first connector 310 is disclosed as being arranged in an upper rear corner of the inner wall in a position above the chest and drawer guiding rails 108, 109 of the upper most drawer 103. The second connector 311 is arranged in a lower rear corner of the inner wall in a position below the chest and drawer guiding rails 108, 109 of the lower most drawer 103. The first and second connectors 310, 311 are thus disclosed as being arranged along a substantially vertical line. It is however to be understood that they alternatively may be arranged along a line forming an angle to a vertical line. It is also to be understood that the first and second connectors 310, 311 must not be arranged at the same wall of the chest of drawers 100 as the chest guiding rails 109. The first and second connectors 310, 311 may by way of example be arranged on an inner surface of the rear wall 101 of the chest of drawers 100. No matter position it is though preferred that the first and second connectors 310, 311 are arranged in positions above the upper most drawer 103 and below the lower most drawer 103.

The first connector 310 is attached to a first end of the wire 308. The second connector 11 is attached to a second end of the wire 308. Further, the wire 308 extends through the loops 306 in each of the wire guide members 302 of the at least two chest guide members 109. In the event the chest of drawers 100 is of the type that is to be assembled by the client, it is advantageous that one single aggregate comprising the connectors 310, 311, and the wire guide members 32 with or without the chest guide members 109 is provided with the wire 8 extending from the first connector 310 to the second connector while passing through the respective loops 306.

The wire 308 may by way of example be a single or multi-stranded metal wire or a woven ribbon. The wire 308 is preferably non-flexible along its longitudinal extension and bendable relative to its longitudinal extension.

The first connector 310 is disclosed as being a biasing member 312 configured to exert a pulling force to the wire 308 along its longitudinal extension. The biasing member 312 may in one embodiment be a spring biased pulley. Such spring biased pulleys are by way of example well known from key holders and card holders.

The second connector 311 is disclosed as being a rigid connector fixedly connector to the bottom wall 112 of the chest of drawer 100. Alternatively, the second connector 311 may be fixedly connected to e.g. the inner wall portion of the side wall 102 of the chest of drawers 100 or even the bottom wall or rear wall 101 of the chest of drawers 100.

The skilled person realises that the same function may be achieved by instead providing the second connector 311 as a biasing member while the first connector 310 is a rigid connector fixedly connected to the chest of drawers 100.

The biasing member 312 may in another (non-shown) embodiment be a counterweight connected to a free end of the wire 308. The biasing member 312 may in yet another embodiment be an elastic member such as a spring or a rubber band. The purpose of the biasing member 312 will be further discussed below.

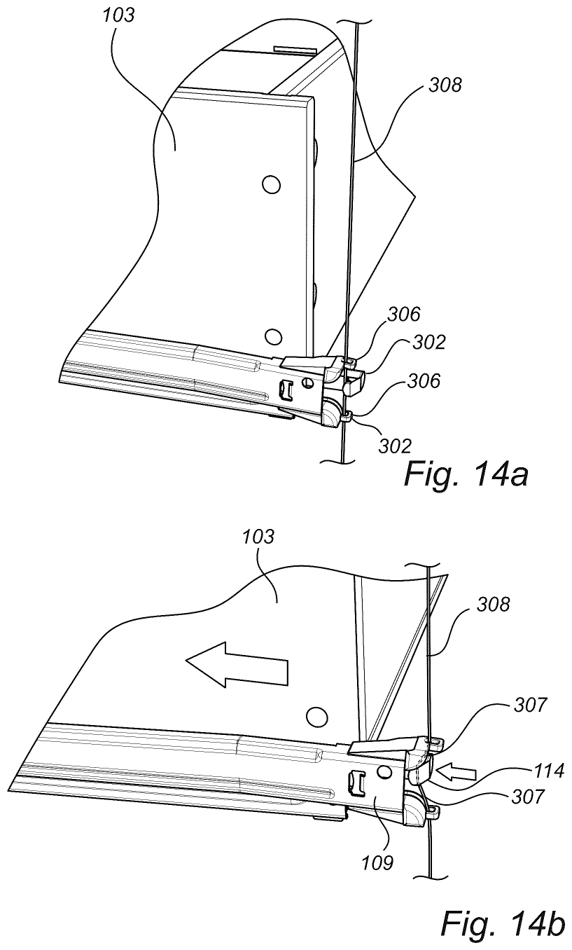

Now turning to FIGS. 10 and 13, one embodiment of a pulling member 313 is disclosed. Each drawer 103 comprises in a rear end thereof a pulling member 313. Each pulling member 313 comprises a hook 314 which is configured to interact with the wire 308. FIG. 13 discloses one embodiment of the pulling member 313. The disclosed embodiment comprises a pin 315 having an insertion portion 316, a neck portion 317 and the hook 314. The insertion portion 316 is configured to be inserted into a hole 113 in one of the two side panels 105 of the drawer 103. The pulling member 313 is in the disclosed embodiment provided with an extension in parallel with the longitudinal extension of the side panel 105. The neck portion 317 is configured, as seen in a condition when the pulling member 313 is mounted to the side panel 105, to serve as a distance that positions the hook 314 in a position closer to the rear wall 101 of the chest of drawers 102 than to the wire 308.

The pulling member 313 of each drawer 103 is in the disclosed embodiment arranged in a position on the drawer 103 in which it is allowed to pass between the two wire guide members 302 during opening of the drawer 103. Thus, the pulling member 313 is arranged in a position along the height of the drawer 103 so that the hook 314 is arranged in vertical position between the two curved portions of the two wire guide members 302 that are mounted to the chest guiding rail 109.

The pulling member 313 may be an integral part of an interconnection member configured to interconnect a side wall of the drawer 103 with a rear panel 106 of the drawer 103. Thereby it may be is ensured that the pulling member 313 is mounted during the assembly of the drawer 103 and it is prevented that the user deliberately omits the mounting of the pulling member 313 to thereby set aside the intended safety function of the drawer displacement restriction system 300. The pulling member 13 may hence be provided with an interconnection member that comprises a protrusion configured to be inserted into a though going opening in the side wall of the drawer 103 and into a recess in an edge surface of the rear panel 106 of the drawer 103. Such protrusion thereby serves as a plug that extends through the side wall of the drawer 103 and into the edge surface of the rear panel 106 of the drawer 103. The protrusion is preferably provided with a through-going channel configured to receive a screw. The screw may in turn be configured to lockingly engage a locking nut arranged in the rear panel 106 of the drawer 103.

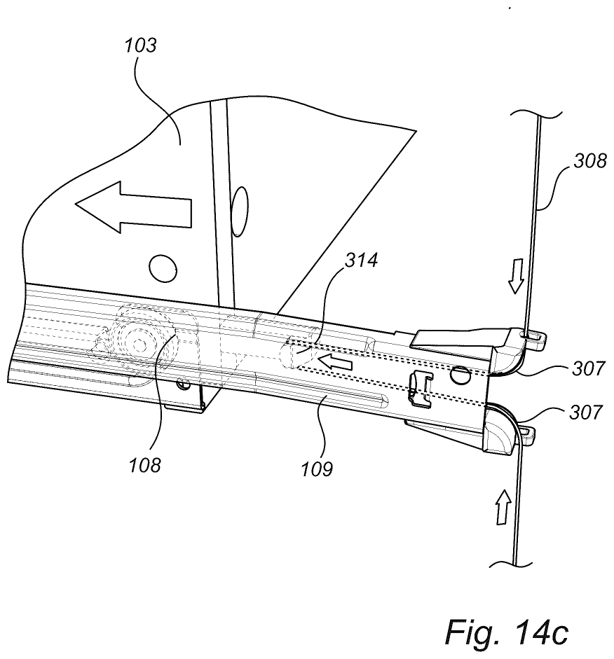

Now turning to FIGS. 14a-14c, the operation of the present invention will be discussed. Starting with FIG. 14a, the rear end portion of one drawer 103 is disclosed. The wire 308 extending between the first and second connectors (omitted in FIG. 14a) extends through the two loops 306 of the two wire guide members 302. Also, the hook 314 which is fixedly supported by the drawer 103 is arranged behind the wire 308, i.e. in a position between the rear wall 101 of the chest of drawers 100 and the wire 308.

Now turning to FIGS. 14b and 14c, the drawer 103 is disclosed as being pulled to open the same, see arrow. As the drawer 103 is pulled, the hook 314 will engage and pull the wire 308 and hence force the same into an engagement with the two opposing curved portions 307 of the wire guide member 302. As the pulling of the drawer 103 continues, the hook 314 will pull the wire 308 into the interior of the chest guiding rail 109. The curved portions 307 of the two wire guide members 302 form diverting surfaces around which the wire 308 is forced to temporarily change its longitudinal direction during opening of the specific drawer 103. Also, by the curved portions 307, the wire 308 is prevented from being misaligned.

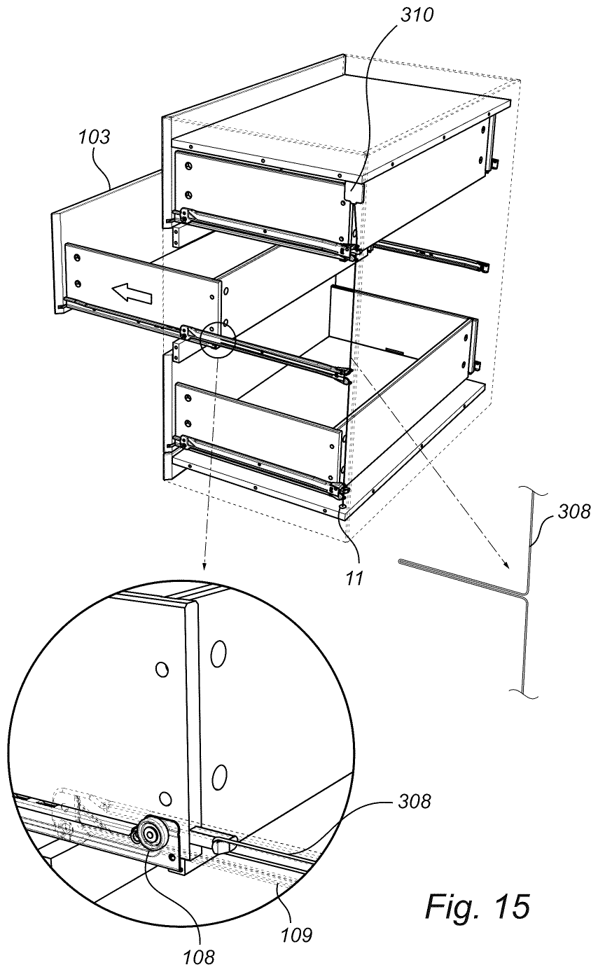

The wire 308, which as such is non-flexible along its longitudinal extension, will be allowed by the biasing member 312 to be pulled along to such extent that the drawer 103 can be fully opened, see FIG. 15. The wire 308 has an available length such that the drawer displacement restriction system 1 allows either one drawer 103 only to be fully opened, or two or more drawers 103 to be only partly opened. In this context, the “available length” is to be understood as the sum of the distance between the first and second connectors 310, 311 and the extra wire length that may be provided by the pulling member 313. The extra wire length provided by the pulling member 313 may be provided as a length being wound on a pulley of the biasing member 312, available displacement of a movable counterweight, or by elastically stretching the wire 308 as the pulling member 313 pulls the wire 308 during opening of one or more drawers 103. The available length of the wire 308 is dimensioned so that the number of drawers 103 that may be opened simultaneously is restricted. This is a safety measure that restricts the displacement of the center of gravity to such extent that the chest of drawers 100 is prevented, or at least substantially stopped, from tipping over.

Since the pulling member 313 of each drawer 103 is arranged in a position on the drawer 103 in which it is allowed to pass between the two wire guide members 302 during opening of the drawer 103, the wire 308 will be pulled along the interior of the chest guiding rail 109 as the drawer 103 is opened. This is the result of the wire guide member 302 with its loop 306 being connected to the drawer guiding rail 108 and the wire 308 extending through the loops 306 in the wire guide members 302. In this manner, the wire 308 is protected from getting entangled with any foreign items during opening/closing of the drawer 103. Depending on the design of the chest guiding rail 109, which is in some embodiments at least partly may encircle the drawer guiding rail 108 as seen along the longitudinal extension of the two rails.

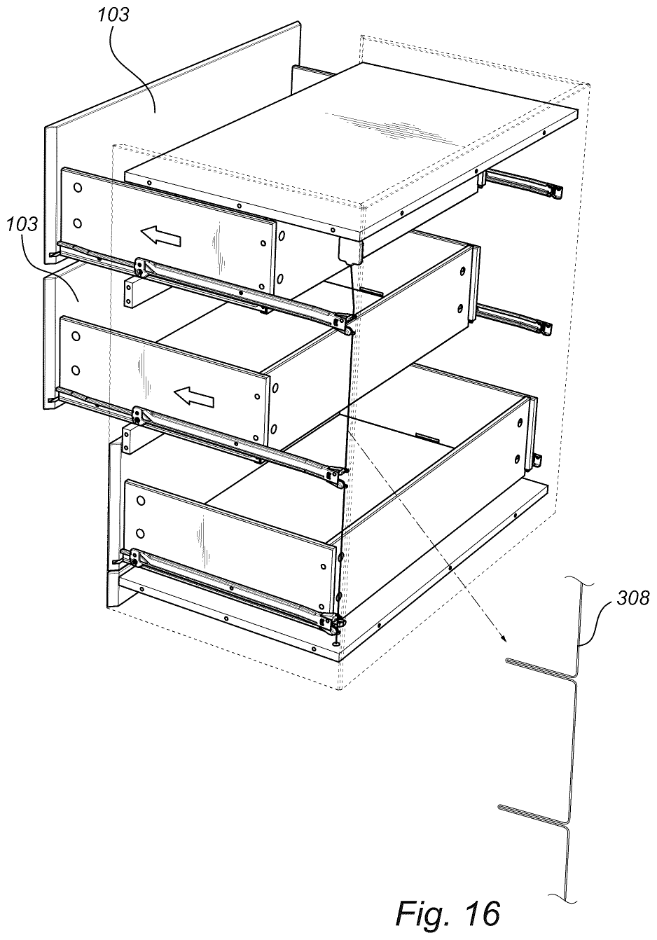

Now turning to FIG. 16, a situation is disclosed where two drawers 103 are opened simultaneously. All drawers 103 in the chest of drawers 100 share the common wire 308 and the available length of the wire 308 is adapted to allow, either one drawer 103 to be fully opened (as is disclosed in FIG. 15) or two or more drawers 103 to be only partly opened at one and the same time. Thus, even though two drawers 103 are disclosed as being opened halfway, the same principle applies if more than two drawers 103 should be opened at the same time. The only difference will then be to which extent the number of drawers 103 may be opened. Also, it should be stressed that the drawers 103 can be opened to mutually different extents.

As discussed above, at least one of the first and second connectors 310, 311 may comprise a biasing member 312 configured to exert a pulling force to the wire 308 along the longitudinal extension of the wire 308. The biasing member 312 contributes to close a drawer 103 when being set to an opened, or partially opened position. It is though preferred that the biasing force is lower than the force that is required to be applied to a drawer 103 in order to overcome the frictional engagement to displace the same from an opened of partially opened position to a closed position. However, once the frictional force has been overruled and the drawer 103 has started to move towards its closed position, the biasing force will positively contribute to the displacement of the drawer 103.

Accordingly, a drawer displacement restriction system 300 is provided in which the at least two chest guiding rails 109 are interconnected via a wire 308 that extends through a respective loop 306 in each and one of the two chest guiding rails 109. Thereby a highly simplified mounting process is provided for, wherein the user may receive the wire 308 and the at least two chest guiding rails 109, the wire connecting members 302 and the connectors 310, 311 as one single aggregate. During assembly of the chest of drawers 100, the user may mount the respective chest guiding rails 109 to dedicated positions represented by patterns of pre-formed openings in the first side wall 102 of the chest of drawers 100 in the very same way as is normally made when assembling a chest of drawers 100 of the self-assembly type. During this process, the wire 308 will automatically be oriented into its intended position Alternatively, the wire 308 and the at least two chest guiding rails 109 may be delivered pre-mounted to the side wall 102 of the chest of drawers 100. By the wire 308 being delivered in a condition where the wire 308 extends through a respective loop 306 in each of the wire guide members 302 of the at least two chest guiding rails 109, any person who would like to set aside the function of the wire 308, must deliberately remove e.g., by cutting, the wire 308.

The drawer displacement restriction system 1 has been exemplified as being applied to a chest of drawers 100. It is to be understood that the arrangement is equally applicable to other types of furniture with drawers where the center of gravity may be changed during use. Non-limiting examples are office furniture and file cabinets.

***

The secondary alternative embodiment of the drawer displacement restriction system 300 may be defined as follows:

Item 1: a Drawer Displacement Restriction System (300), Wherein the System comprises:
at least two chest guiding rails (109), each chest guiding rail (109) being configured to be fixedly connected to a first side wall (102) of a chest of drawers (100) and each chest guiding rail (109) being configured to guide a drawer guiding rail (108) of a respective drawer (103);
a wire (308) configured to extend along a wall of the chest of drawers (100);
at least two pulling members (313), each pulling member (313) being configured to be fixedly arranged to a respective drawer (103) and to selectively interact with the wire (308); and
wherein the wire (308) is configured to extend through a respective loop (306) in each of the at least two chest guiding rails (109).

Item 2: The drawer displacement restriction system according to item 1 wherein the wire (308) has a length such that the drawer displacement restriction system (300) allows either one drawer (103) only to be fully opened, or two or more drawers (103) to be only partly opened.

Item 3: The drawer displacement restriction system according to item 1 or 2, wherein each chest guiding rail (109) in an end configured to face a rear wall (101) of the chest of drawers (100) comprises a wire guide member (302), and wherein the loop (306) is formed by said wire guide member (302).

Item 4: The drawer displacement restriction system according to item 1 or 2, wherein each chest guiding rail (109) in an end configured to face a rear wall (101) of the chest of drawers (100) comprises two wire guide members (302), each wire guide member (302) comprising a loop (306), and wherein the wire (308) is configured to extend through both loops (306).

Item 5: The drawer displacement restriction system according to item 4, wherein the pulling member (313) of each drawer (103) is arranged in a position on the drawer (103) in which it is allowed to pass between the two wire guide members (302) during opening of the drawer (103).

Item 6: The drawer displacement restriction system according to any of the preceding items, further comprising:
a first connector (310) configured to be attached to a first end of the wire (308), the first connector (310) being configured to be attached to a wall of the chest of drawers (100) at a first position; and
a second connector (311) configured to be attached to a second end of the wire (308), the second connector (311) being configured to be attached to a wall of the chest of drawers (100) at a second position; wherein the wire (308) is configured to extend between the first and second positions.

Item 7: The drawer displacement restriction system according to item 6, wherein at least one of the first and second connectors (310, 311) comprises a biasing member (312) configured to exert a pulling force to the wire (308) along the longitudinal extension of the wire (308).

Item 8: The drawer displacement restriction system according to any or the preceding items, wherein the wire (308) is non-flexible along its longitudinal extension and bendable relative to its longitudinal extension.

Item 9: A chest of drawer (100) comprising a first and a second side wall (102) opposing each other, at least two drawers (103), and a drawer displacement restriction system (301), wherein the drawer displacement restriction system (301) comprises:
at least two chest guiding rails (109) fixedly connected to the first side wall (102) of the chest of drawers (100), each chest guiding rail (109) being configured to guide a drawer guiding rail (108) of a respective drawer (103);
a wire (308) extending along a wall of the chest of drawers (100);
at least two pulling members (13), each pulling member (313) being fixedly arranged to a respective drawer (103) and being configured to selectively interact with the wire (308) during pulling out of one or more of the at least two drawers (103); and
wherein the wire (308) extends through a respective loop (306) in each of the at least two chest guiding rails (109).

1. A drawer displacement restriction system, wherein the system comprises:
at least two drawers, each drawer having a rear panel connecting with two opposing side panels;
at least two pairs of wire guiding members, each pair being configured to be supported by a wall of the a chest of drawers in a position adjacent a respective drawer;
a wire being configured to extend along a wall of the chest of drawers and through a channel in each wire guiding member in the at least two pairs of wire guiding members; and
at least two pulling members, wherein each of the at least two drawers being configured support a respective pulling member; wherein
one of the at least two pulling members is configured to selectively engage the wire in a position between two wire guiding members in a pair of wire guiding members during opening of a drawer associated with said pulling member.

2. The drawer displacement restriction system according to claim 1, wherein the wire is configured to extend along one of two opposing side walls of the chest of drawers, and wherein each pair of the wire guiding members is configured to be supported by a same side wall of the two opposing side walls of the chest of drawers.

3. The drawer displacement restriction system according to claim 2, wherein the pulling member is an integral part of an interconnection member configured to interconnect a side panel of the drawer with a rear panel of the drawer.

4. The drawer displacement restriction system according to claim 1, wherein the pulling member comprises a hook, and wherein said pulling member is configured to selectively engage the wire by means of said hook.

5. The drawer displacement restriction system according to claim 1, wherein the wire has a length such that the drawer displacement restriction system allows either one drawer only to be fully opened, or two or more drawers to be only partly opened.

6. The drawer displacement restriction system according to claim 1, further comprising:
a first connector configured to be attached to a first end of the wire, the first connector being configured to be attached to a wall of the chest of drawers at a first position; and
a stopper configured to be attached to a second end of the wire.

7. The drawer displacement restriction system according to claim 6, wherein at least one of the first connector and the stopper comprises a biasing member configured to exert a pulling force to the wire along a longitudinal extension of the wire

8. The drawer displacement restriction system according to claim 7, wherein the stopper is a second connector configured to be attached to a wall of the chest of drawers at a second position, wherein the wire is configured to extend between the first and second positions.

9. The drawer displacement restriction system according to claim 1, wherein the wire is non-flexible along a longitudinal extension or the wire and bendable relative to the longitudinal extension.

10. The drawer displacement restriction system according to claim 1, wherein the channel in each wire guiding member comprises an inlet opening, an outlet opening and an envelope surface extending between the inlet and outlet openings, wherein the envelope surface comprises a straight first wall portion and a single-curved second wall portion opposite the straight first wall portion, and wherein the wire is configured to be forced by the pulling member towards and into abutment with the single-curved wall portion during opening of a drawer.

11. The drawer displacement restriction system according to claim 1, wherein the wire guiding member comprises a first protrusion configured to be received in a recess in a side wall of the chest of drawers, and a second protrusion configured to be received in a recess that partially overlaps a groove configured to receive a rear wall of the chest of drawers.

12. A chest of drawers comprising a first and a second side wall opposing each other, at least two drawers, each drawer having a rear panel connecting with two opposing side panels, and a drawer displacement restriction system, wherein the drawer displacement restriction system comprises:
at least two pairs of wire guiding members, each pair being supported by a wall of the chest of drawers in a position adjacent a respective drawer;
a wire extending along a wall of the chest of drawers and through a channel in each wire guiding member in the at least two pairs of wire guiding members; and
a pulling member connected to each of the at least two drawers; wherein
the pulling member of a respective drawer is configured to selectively engage the wire in a position between two wire guiding members in a pair of wire guiding members during opening of said drawer.

13. An aggregate to be used in the drawer displacement system according to claim 1, said aggregate comprising:
at least two pairs of wire guiding members, each wire guiding member comprising a through-going channel;
a wire extending through the channel of each wire guiding member;
a first connector attached to a first end of the wire; and
a stopper or second connector attached to a second end of the wire.

14. The drawer displacement restriction system according to claim 1, wherein the pulling member is an integral part of an interconnection member configured to interconnect a side panel of the drawer with a rear panel of the drawer.

15. The drawer displacement restriction system according to claim 6, wherein the stopper is a second connector configured to be attached to a wall of the chest of drawers at a second position, wherein the wire is configured to extend between the first and second positions.
